(19) United States
(12) Patent Application Publication
(10) Pub. No.: US 2022/0140446 A1
(43) Pub. Date: May 5, 2022

(54) POSITIVE-AND-NEGATIVE ELECTRODE FIXTURE OF BATTERY MODULES

(71) Applicant: Huizhou Poypow Technology Co., Ltd, Huizhou (CN)

(72) Inventors: Quanfu ZOU, Huizhou (CN); Guoai HUANG, Huizhou (CN)

(73) Assignee: Huizhou Poypow Technology Co., Ltd, Huizhou (CN)

(21) Appl. No.: 17/516,899

(22) Filed: Nov. 2, 2021

(30) Foreign Application Priority Data
Nov. 2, 2020 (CN) 202022493520.4

(51) Int. Cl. H01M 50/505; H01M 50/516; H01M 50/517

(52) U.S. Cl. CPC H01M 50/505; H01M 50/517; H01M 50/516

(57) ABSTRACT

A positive-and-negative electrode fixture of battery modules is provided, comprising the following components: a battery module body; a module end plate, located at the front and back of the battery module body, respectively; a busbar insulation fixture, clamped on the module end plate; and a busbar, arranged on the upper end face of the busbar insulation fixture, having one side fixedly connected with the battery module body and the other side fixedly connected with the busbar insulation fixture through a bolt and a nut, with the nut arranged between the busbar insulation fixture and the busbar. The present invention has such advantages as simple structure, convenient installation and disassembly and replacement of parts, improved production efficiency and reduced production cost, stable structure, high connection reliability, and strong overcurrent capacity.

### CROSS-REFERENCE TO RELATED APPLICATIONS

Benefit is claimed to Chinese Patent Application No. 202022493520.4, filed on Nov. 2, 2020, the contents of which are incorporated by reference herein in their entirety.

### FIELD

The invention relates to the technical field of batteries, in particular to a positive-and-negative electrode fixture of battery modules.

### BACKGROUND

As the power source of electric vehicles, batteries can achieve zero pollution during use, can effectively solve the pollution and energy problems of electric vehicles, and is conducive to reducing urban air pollution, thus having application prospects widely considered promising. The positive and negative electrodes of battery modules in the prior art are designed in such a way that direct injection molding of hot-melt nuts is used in the plastic busbar insulation fixtures, which is prone to the following problems:

1. If the locking force of the bolt applied to the positive and negative electrodes is large, or the strength of the hot-melt nut to fix the plastic member is insufficient, the hot-melt nut may be pulled out;

2. when the positive and negative electrodes of the battery module are connected to the busbar, the current will flow through the bolt and nut; if the end face of the hot-melt nut does not touch the busbar, there will be no current between the nut and the busbar, thereby reducing the overcurrent capacity; and

3. the manufacturing process of plastic hot-melt nuts is relatively complicated, and the cost of injection molding is relatively high.

### SUMMARY

The object of the present invention is to provide a positive-and-negative electrode fixture of battery modules, so as to solve the above technical problems. The present invention has such advantages as simple structure, convenient installation and disassembly and replacement of parts, improved production efficiency and reduced production cost, stable structure, high connection reliability, and strong overcurrent capacity.

In order to achieve the above object, the present invention adopts the following technical solution:

A positive-and-negative electrode fixture of battery modules is provided, comprising the following components: a battery module body; a module end plate, located at the front and back of the battery module body, respectively; a busbar insulation fixture, clamped on the module end plate; and a busbar, arranged on the upper end face of the busbar insulation fixture, having one side fixedly connected with the battery module body and the other side fixedly connected with the busbar insulation fixture through a bolt and a nut, with the nut arranged between the busbar insulation fixture and the busbar. The positive-and-negative electrode fixture of battery modules of the present invention mainly comprises a battery module body, a module end plate, a busbar insulation fixture, a busbar and a nut, having few components and simple structure; the busbar insulation fixture is clamped with the module end plate and fixedly connected with the busbar through a bolt and a nut, which can facilitate the installation, disassembly and replacement of the busbar insulation fixture.

Preferably, the module end plate, being hollow, is provided at its upper end with a clamping site for the busbar insulation fixture to be clamped, with a clamping hole provided on the outer surface of the clamping site. The arrangement of the clamping site and the clamping hole can facilitate the positioning and installation of the busbar insulation fixture.

Preferably, the busbar insulation fixture is provided at the upper portion with a nut limit groove and at the lower portion with a clamping portion, with the nut arranged in the nut limit groove and a buckle provided on the clamping portion. On the one hand, the arrangement of the nut limit groove can facilitate the positioning and placement of the nut, so that the nut does not need to be molten together with the busbar insulation fixture, thereby simplifying the injection molding process of the busbar insulation fixture, improving the production efficiency of the busbar insulation fixture, and reducing the production cost; on the other hand, the nut limit groove can prevent the nut from rotating under the action of torsion, thereby increasing the bearing capacity of the nut, so that the nut can withstand greater rotating torsion of the bolt.

Preferably, the busbar insulation fixture is made of insulating materials.

Preferably, the battery module body comprises a battery cell assembly module, and a side plate arranged on the left and right sides of the battery cell assembly module; the module end plate is clamped between the left and right side plates and located at the front and back of the battery module body.

Preferably, the busbar has one side welded to the battery cell assembly module.

Preferably, with the nuts all made of metal materials, when the bolt is screwed into the nut to fix the busbar, the nut can be in direct contact with the busbar, so as to increase the contact area between the nut and the busbar, thereby increasing the overcurrent capacity of the present invention.

The positive-and-negative electrode fixture of battery modules of the present invention has the following beneficial effects:

1. Simple structure: the positive-and-negative electrode fixture of battery modules of the present invention mainly comprises a battery module body, a module end plate, a busbar insulation fixture, a busbar and a nut, having few components and simple structure;

2. facilitating installation, disassembly and replacement of parts: the busbar insulation fixture is clamped with the module end plate and fixedly connected with the busbar through a bolt and a nut, which can facilitate the installation, disassembly and replacement of the busbar insulation fixture;

3. improving production efficiency and reducing production cost: the busbar insulation fixture is provided at the upper portion with a nut limit groove, which can facilitate the positioning and placement of the nut, so that the nut does not need to be molten together with the busbar insulation fixture, thereby simplifying the injection molding process of the busbar insulation fixture, improving the production efficiency of the busbar insulation fixture, and reducing the production cost;

4. the positive-and-negative electrode fixture of battery modules is stable and has high connection reliability: the busbar insulation fixture is provided at the upper portion with a nut limit groove, which can prevent the nut from rotating under the action of torsion and then increase the bearing capacity of the nut, so that the nut can withstand greater rotating torsion of the bolt, making the positive-and-negative electrode fixture of battery modules stable and having high connection reliability:

5. increasing overcurrent capacity: with the nuts all made of metal materials, when the bolt is screwed into the nut to fix the busbar, the nut can be in direct contact with the busbar, so as to increase the contact area between the nut and the busbar, thereby increasing the overcurrent capacity of the present invention.

### BRIEF DESCRIPTION OF THE DRAWINGS

FIG. 1 is an overall schematic diagram of the positive-and-negative electrode fixture of battery modules of the invention;

FIG. 2 is a partial exploded view of the positive-and-negative electrode fixture of battery modules of the invention;

FIG. 3 is a schematic diagram of the structure of the module end plate in FIG. 1; and

FIG. 4 is a schematic diagram of the structure of the busbar insulation fixture in FIG. 1.

### DETAILED DESCRIPTION OF THE EMBODIMENTS

In order to enable those skilled in the art to better understand the technical solutions of the present invention, the products of the present invention will be further described in detail below in conjunction with examples and drawings.

It should be noted that when an element A is said to be “fixed on” an element B, the element A can be directly on the element B or there may be an element C in between; when an element A is said to be “connected to/with” an element B, the element A can be directly connected to/with the element B or there may be an element C in between. The terms “vertical”, “horizontal”, “left”, “right” and other similar expressions used herein are only for the purpose of illustration, and do not mean that they are the only embodiments.

Unless otherwise defined, all scientific and technological terms used herein have the same meanings as commonly understood by those skilled in the art of the present invention. The terms used in the description of the present invention herein are only for the purpose of describing specific embodiments, and are not intended to limit the present invention. The term “and/or” as used herein includes any and all combinations of one or more related listed items.

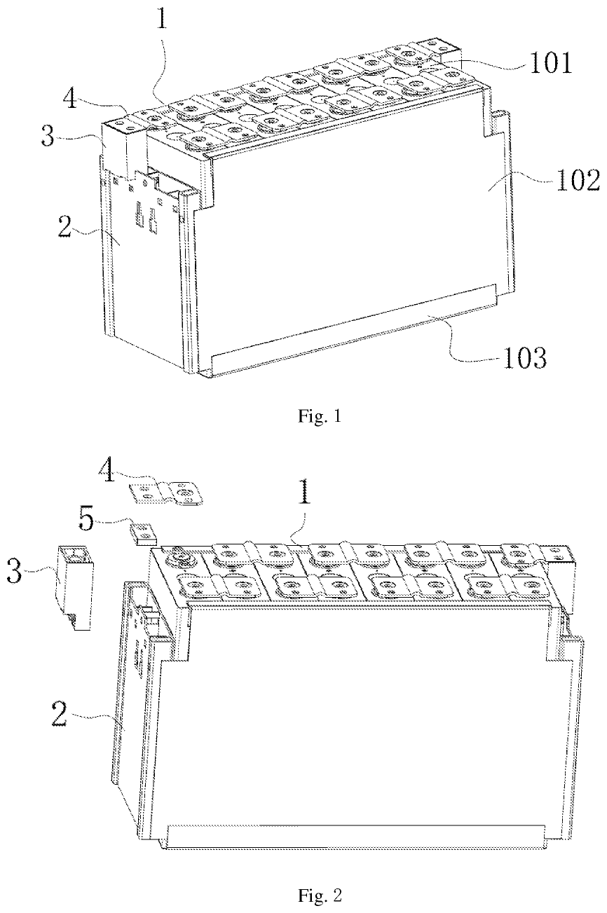

As shown in FIGS. 1 and 2, a positive-and-negative electrode fixture of battery modules includes a battery module body 1, which comprises a battery cell assembly module 101, a side plate 102 arranged on the left and right sides of the battery cell assembly module 101, and a bottom plate 103 arranged at the bottom of the battery cell assembly module 101; the arrangement of the side plate 102 and the bottom plate 103 can prevent the battery cell assembly module 101 from being scratched by foreign objects or dampened, thus protecting the battery cell assembly module 101. The side plate 102 is provided on both side edges with an extension edge, so that a module end plate clamping site is formed at the front and back of the battery module body 1; a module end plate 2 is provided at the module end plate clamping site; a busbar insulation fixture 3 is clamped on the module end plate 2; a busbar 4 is arranged on the upper end face of the busbar insulation fixture 3, having one side welded to the battery cell assembly module 101 and the other side fixedly connected with the busbar insulation fixture 3 through a bolt and a nut 5, with the nut 5 arranged between the busbar insulation fixture 3 and the busbar 4; the nut 5, flat as a whole and made of stainless steel, is provided with two screw holes, which correspond to the screw holes of the busbar 4; when the bolt is screwed into the nut 5 to fix the busbar 4, the nut 5 can be in direct contact with the busbar 4, so as to increase the contact area between the nut 5 and the busbar 4, thereby increasing the overcurrent capacity of the present invention.

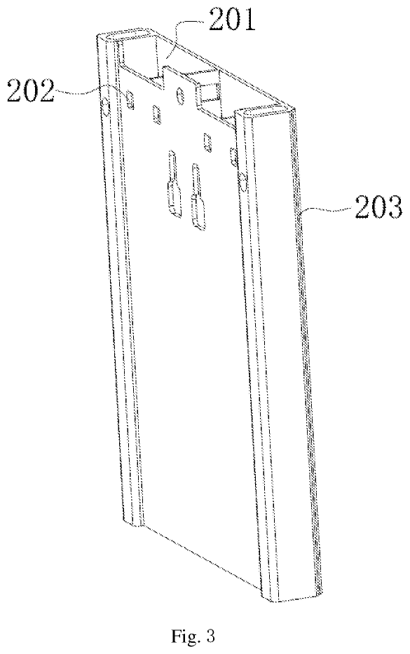

As shown in FIG. 3, the module end plate 2 is made of plastic materials by injection molding and hollow in the middle, which can save the raw materials for producing the module end plate 2 on the one hand, and reduce the overall weight of the module end plate 2 on the other hand; the module end plate 2 is provided with a positioning slot 203 on both side edges, so as to facilitate the module end plate 2 to be clamped at the module end plate clamping site at the front and back of the battery module body; the module end plate 2 is provided at its upper end with a clamping site 201 for the busbar insulation fixture 3 to be clamped, with a clamping hole 202 provided on the outer surface of the clamping site 201, the arrangement of the clamping site 201 and the clamping hole 202 facilitating the positioning and installation of the busbar insulation fixture 3.

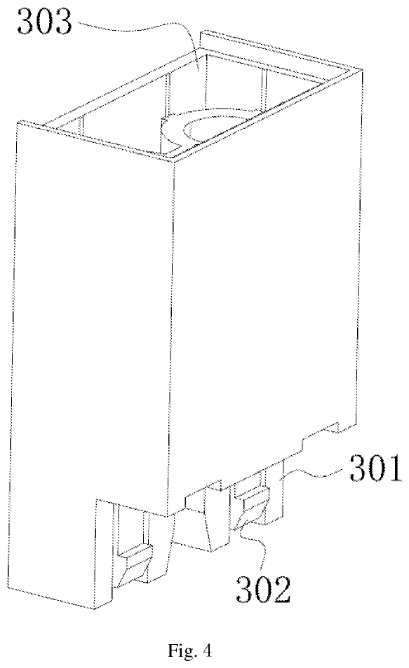

As shown in FIG. 4, the busbar insulation fixture 3, provided at the upper portion with a nut limit groove 303, is made of insulating materials, and made of plastic materials by injection molding in this example; with the nut 5 arranged in the nut limit groove 303; on the one hand, the arrangement of the nut limit groove 303 can facilitate the positioning and placement of the nut 5, so that the nut 5 does not need to be molten together with the busbar insulation fixture 3, thereby simplifying the injection molding process of the busbar insulation fixture 3, improving the production efficiency of the busbar insulation fixture 3, and reducing the production cost; on the other hand, the nut limit groove 303 can prevent the nut 5 from rotating under the action of torsion, thereby increasing the bearing capacity of the nut 5, so that the nut 5 can withstand greater rotating torsion of the bolt; the busbar insulation fixture 3 is provided at the lower portion with a clamping portion 301, which is provided with a buckle 302; in order to install the busbar insulation fixture 3, the clamping portion 301 is inserted into the clamping site 201 of the module end plate 2, so that the buckle 302 is clamped into the clamping hole 202, which can restrict and then fix the busbar insulation fixture 3; when it is necessary to replace or disassemble the busbar insulation fixture 3, just the buckle 302 is pressed inward to free it from the restriction of the clamping hole 202, and then the busbar insulation fixture 3 can be pulled out, thereby facilitating the disassembly and replacement of the busbar insulation fixture 3.

The above embodiments are only the preferred ones of the present invention, and do not impose any formal restrictions on the present invention. Those of ordinary skill in the art can smoothly implement the present invention according to the drawings of the description and the contents described above. However, all those skilled in the art can make use of the technical contents disclosed above to make minor equivalent alterations, modifications and evolutions without departing from the scope of the technical solution of the present invention; besides, any equivalent alterations, modifications and evolutions made to the above examples based on the essential technology of the present invention are still within the protection scope of the technical solution of the present invention.

We claim:

1. A positive-and-negative electrode fixture of battery modules, comprising a battery module body (1), characterized in that: a module end plate (2) is located at the front and back of the battery module body (1), respectively; a busbar insulation fixture (3) is clamped on the module end plate (2); and a busbar (4) is arranged on the upper end face of the busbar insulation fixture (3), having one side fixedly connected with the battery module body (1) and the other side fixedly connected with the busbar insulation fixture (3) through a bolt and a nut (5), with the nut (5) arranged between the busbar insulation fixture (3) and the busbar (4).

2. The positive-and-negative electrode fixture of battery modules according to claim 1, characterized in that: the module end plate (2), being hollow, is provided at its upper end with a clamping site (201) for the busbar insulation fixture (3) to be clamped, with a clamping hole (202) provided on the outer surface of the clamping site (201).

3. The positive-and-negative electrode fixture of battery modules according to claim 1, characterized in that: the busbar insulation fixture (3) is provided at the upper portion with a nut limit groove (303) and at the lower portion with a clamping portion (301), with the nut (5) arranged in the nut limit groove (303) and a buckle (302) provided on the clamping portion (301).

4. The positive-and-negative electrode fixture of battery modules according to claim 1, characterized in that: the busbar insulation fixture (3) is made of insulating materials.

5. The positive-and-negative electrode fixture of battery modules according to claim 1, characterized in that: the battery module body (1) comprises a battery cell assembly module (101), and a side plate (102) arranged on the left and right sides of the battery cell assembly module (101); the module end plate (2) is clamped between the left and right side plates (102) and located at the front and back of the battery module body (1).

6. The positive-and-negative electrode fixture of battery modules according to claim 5, characterized in that: the busbar (4) has one side welded to the battery cell assembly module (101).

7. The positive-and-negative electrode fixture of battery modules according to claim 1, characterized in that: the nuts (5) are all made of metal materials.
